(19) United States
(12) Patent Application Publication
(10) Pub. No.: US 2016/0011458 A1
(43) Pub. Date: Jan. 14, 2016

(54) ARRAY SUBSTRATE, METHOD OF MANUFACTURING THE SAME, AND LIQUID CRYSTAL DISPLAY APPARATUS

(71) Applicant: BOE Technology Group Co., Ltd., Beijing (CN)

(72) Inventors: Zhiqiang Xu, Beijing (CN); Hee Cheol Kim, Beijing (CN); Chao Xu, Beijing (CN)

(73) Assignee: BOE Technology Group Co., Ltd., Beijing (CN)

(21) Appl. No.: 14/409,841

(22) PCT Filed: Apr. 30, 2014
(86) PCT No.: PCT/CN2014/076629

§ 371 Date: Dec. 19, 2014

(30) Foreign Application Priority Data
Dec. 12, 2013 (CN) 201310681176.3

(51) Int. Cl. G02F 1/1335; G02F 1/1343

(52) U.S. Cl. CPC G02F 1/133528; G02F 1/134309; G02F 1/133514; G02F 2001/134345

(57) ABSTRACT

The present invention discloses an array substrate, a method of manufacturing the same, and a liquid crystal display apparatus. The present invention relates a display technical field, and an object of which is to reduce a display chromatic aberration and improve a display effect. The array substrate comprises a plurality of pixel units arranged in an array. The pixel units each comprise at least a first sub pixel unit, a second sub pixel unit and a third sub pixel unit. The sub pixel units each comprise a pixel electrode, a common electrode and an orientation layer. At least one of the pixel electrode and the common electrode in each of the sub pixel units is configured to be a strip electrode. The strip electrode of the first sub pixel unit defines a first angle with respect to an orientation of the orientation layer, the strip electrode of the second sub pixel unit defines a second angle with respect to the orientation of the orientation layer, the strip electrode of the third sub pixel unit defines a third angle with respect to the orientation of the orientation layer. At least two of the first angle, the second angle and the third angle are not equal to each other.

### CROSS-REFERENCE TO RELATED APPLICATION

This application is a Section 371 National Stage application of International Application No. PCT/CN2014/076629, filed 30 Apr. 2014, which has not yet published, which claims priority to Chinese Application 201310681176.3, filed Dec. 12, 2013, in Chinese, the contents of which are hereby incorporated by reference in their entirety.

### BACKGROUND OF THE INVENTION

1. Field of the Invention

The present invention relates to a display technical field, more particularly, relates to an array substrate, a method of manufacturing the array substrate, and a liquid crystal display apparatus comprising the array substrate.

2. Description of the Related Art

A thin film transistor-liquid crystal display (or simply referred as TFT-LCD) mainly comprises a liquid crystal display panel, polarizers disposed on both sides of the liquid crystal display panel, and a backlight source. The liquid crystal display panel comprises an array substrate, a package substrate and a liquid crystal layer disposed between the substrates.

A white light emitted from the backlight source is a polychromatic light comprising a red light (with a wavelength of 630 nm), a green light (with a wavelength of 550 nm), a blue light (with a wavelength of 430 nm). After passing through a polarizer outside an array substrate, the white light is converted into a linearly polarized white light. Since the red light, the green light and the blue light have different wavelengths, if the linearly polarized white light passes through a liquid crystal layer with same thickness and same deflection angle, a linearly polarized red light, a linearly polarized green light and a linearly polarized blue light in the linearly polarized white light will show different degrees of optical phase delay, so that the linearly polarized red light, the linearly polarized green light and the linearly polarized blue light have different degrees of variation in the polarization direction after passing through the liquid crystal layer. As a result, under the same voltage, transmittances of the linearly polarized red light, the linearly polarized green light and the linearly polarized blue light transmitting through a color filter and a polarizer at a light-outputting side of a liquid crystal display panel are different from each other due to differences in the polarization direction. Consequently, there is a chromatic aberration between a color generated by mixing lights of different sub pixel regions in different grayscales and an actual color, which adversely affects the display effect.

### SUMMARY OF THE INVENTION

The present invention has been made to provide an array substrate, a method of manufacturing the array substrate, and a liquid crystal display apparatus comprising the array substrate. An object of the present invention is to reduce chromatic aberration and improve display effect.

In order to achieve the above purpose, the embodiments of the present invention provide the following solutions:

According to an aspect of the present invention, there is provided an array substrate comprising a plurality of pixel units arranged in an array, the pixel units each comprising at least a first sub pixel unit, a second sub pixel unit and a third sub pixel unit, the sub pixel units each comprising a pixel electrode, a common electrode and an orientation layer, wherein at least one of the pixel electrode and the common electrode in each of the sub pixel units is configured to be a strip electrode, the strip electrode of the first sub pixel unit defines a first angle with respect to an orientation of the orientation layer, the strip electrode of the second sub pixel unit defines a second angle with respect to the orientation of the orientation layer, the strip electrode of the third sub pixel unit defines a third angle with respect to the orientation of the orientation layer, and at least two of the first angle, the second angle and the third angle are not equal to each other.

According to another aspect of the present invention, there is provided a liquid crystal display apparatus comprising the above array substrate.

According to an exemplary embodiment of the present invention, the liquid crystal display apparatus further comprises a color filter substrate comprising a color layer. Each of the pixel units in the array substrate comprises the first sub pixel unit, the second sub pixel unit and the third sub pixel unit. The first angle of the strip electrode of the first sub pixel unit with respect to the orientation of the orientation layer is greater than or equal to the second angle of the strip electrode of the second sub pixel unit with respect to the orientation of the orientation layer, and the second angle of the strip electrode of the second sub pixel unit with respect to the orientation of the orientation layer is greater than or equal to the third angle of the strip electrode of the third sub pixel unit with respect to the orientation of the orientation layer. The color layer comprises a red filter corresponding to the first sub pixel unit, a green filter corresponding to the second sub pixel unit, and a blue filter corresponding to the third sub pixel unit. Alternatively, the array substrate further comprises a color filter, and the color filter comprises a red filter corresponding to the first sub pixel unit, a green filter corresponding to the second sub pixel unit, and a blue filter corresponding to the third sub pixel unit.

According to another aspect of the present invention, there is provided a method of manufacturing an array substrate comprising a plurality of pixel units arranged in an array, the pixel units each comprising at least a first sub pixel unit, a second sub pixel unit and a third sub pixel unit, the sub pixel units each comprising a pixel electrode, a common electrode and an orientation layer,

the method comprising step of:

configuring at least one of the pixel electrode and the common electrode in each sub pixel unit to a strip electrode,

wherein the strip electrode of the first sub pixel unit defines a first angle with respect to an orientation of the orientation layer, the strip electrode of the second sub pixel unit defines a second angle with respect to the orientation of the orientation layer, the strip electrode of the third sub pixel unit defines a third angle with respect to the orientation of the orientation layer, and

wherein at least two of the first angle, the second angle and the third angle are not equal to each other.

According to another aspect of the present invention, there is provided a liquid crystal display apparatus, comprising:

a backlight source emitting a white light;

a light-inputting side polarizer, through which the white light from the backlight source is converted into a linearly polarized white light comprising a linearly polarized red light, a linearly polarized green light and a linearly polarized blue light; and

a plurality of pixel units arranged in an array, wherein the pixel units each comprising at least a first sub pixel unit, a second sub pixel unit and a third sub pixel unit, the sub pixel units each comprising a pixel electrode, a common electrode and an orientation layer, at least one of the pixel electrode and the common electrode in each of the sub pixel units is configured to be a strip electrode, the strip electrode of the first sub pixel unit defines a first angle with respect to an orientation of the orientation layer, the strip electrode of the second sub pixel unit defines a second angle with respect to the orientation of the orientation layer, the strip electrode of the third sub pixel unit defines a third angle with respect to the orientation of the orientation layer, and at least two of the first angle, the second angle and the third angle are not equal to each other;

a liquid crystal layer; and

a light-outputting side polarizer,

wherein the first angle, the second angle and the third angle are configured that:

the linearly polarized red light, the linearly polarized green light and the linearly polarized blue light, which have passed through the liquid crystal layer with same thickness and same deflection angle, transmit through the light-outputting side polarizer in substantially the same light transmittance under the same voltage.

In the prior art, an array substrate is applied in a liquid crystal display apparatus. Since a white light emitted from a backlight source is a polychromatic light comprising a red light, a green light, a blue light, the white light, after passing through a polarizer at a light-inputting side of the liquid crystal display apparatus, is converted into a linearly polarized white light. Since the red light, the green light and the blue light in the white light have different wavelengths, if the linearly polarized white light passes through the liquid crystal layer with same thickness and same deflection angle, a linearly polarized red light, a linearly polarized green light and a linearly polarized blue light in the linearly polarized white light will show different degrees of variation in the polarization direction. As a result, under the same voltage, transmittances of the linearly polarized red light, the linearly polarized green light and the linearly polarized blue light transmitting through a polarizer at a light-outputting side of the liquid crystal display panel are different from each other.

In the exemplary embodiments of the present invention, angles of strip electrodes in various sub pixel units of each pixel unit with respect to the orientation of the orientation layer are configured based on a certain relation. In this way, under the same voltage, the linearly polarized red light, the linearly polarized green light and the linearly polarized blue light can transmit through the polarizer at the light-outputting side of the liquid crystal display apparatus in substantially the same light transmittance. Thereby, it reduces the chromatic aberration between a color generated by mixing lights of different sub pixel regions in different grayscales and an actual color, improving the display effect of the liquid crystal display apparatus.

### BRIEF DESCRIPTION OF THE DRAWINGS

In order to describe clearly the embodiments of the present invention or the solutions in the prior art, figures which will be used during the describing are illustrated as follows in a simple way. Obviously, the figures only relate to some embodiments of the present invention, and those skilled in the art may obtain other figures based on these figures without involving any inventive step:

FIG. 1 is an illustrative structure view of a sub pixel unit according to an exemplary embodiment of the present invention;

FIG. 2 is an illustrative structure view of a sub pixel unit according to another exemplary embodiment of the present invention;

FIG. 3 is an illustrative structure view of a sub pixel unit according to further another exemplary embodiment of the present invention;

FIG. 4 is an illustrative plan structure view of a pixel unit according to an exemplary embodiment of the present invention;

FIG. 5 is an illustrative plan structure view of a pixel unit according to another exemplary embodiment of the present invention; and

FIG. 6 shows a voltage-transmittance simulation curve of a liquid crystal display apparatus according to an exemplary embodiment of the present invention.

### REFERENCES LIST

10—array substrate; 10a—first sub pixel unit; 10b—second sub pixel unit; 10c—third sub pixel unit; 10d—fourth sub pixel unit; 100—thin film transistor; 101—pixel electrode; 102—common electrode; 103—orientation layer; 1030—orientation of the orientation layer; 104—strip electrode.

### DETAILED DESCRIPTION OF PREFERRED EMBODIMENTS OF THE INVENTION

Exemplary embodiments of the present disclosure will be described hereinafter in detail with reference to the attached drawings. The embodiments described are only a part of the embodiments of the present invention. Other embodiments obtained by those skilled in the art based on the embodiments of the present invention without involving any inventive step all falls within the scope of the present invention.

According to an exemplary embodiment of the present invention, there is provided a liquid crystal display apparatus comprising an array substrate 10, a package substrate and a liquid crystal layer between the array substrate 10 and the package substrate. In addition, the liquid crystal display apparatus further comprises polarizers provided at both sides of the liquid crystal display apparatus, respectively, and a backlight source.

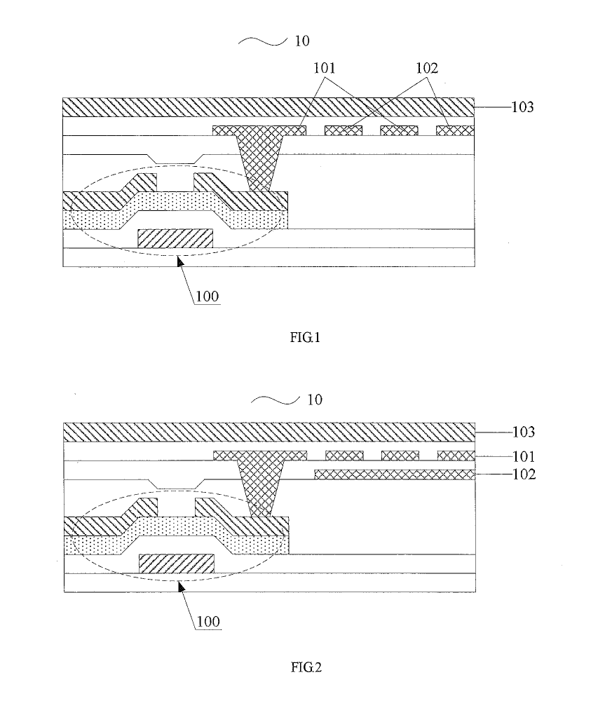

The array substrate 10 comprises a plurality of pixel units arranged in an array. Each of the pixel units comprises at least a first sub pixel unit 10a, a second sub pixel unit 10b and a third sub pixel unit 10c. As shown in FIGS. 1-3, each of the sub pixel units comprises a thin film transistor 100, a pixel electrode 101 electrically connected to a drain electrode of the thin film transistor 100, a common electrode 102, and an orientation layer 103. At least one of the pixel electrode 101 and the common electrode 102 in each of the sub pixel units is configured to be a strip electrode 104.

In an exemplary embodiment, as shown in FIGS. 4-5, at least two of angles of the strip electrodes 104, in the first sub pixel unit 10a, the second sub pixel unit 10b and the third sub pixel unit 10c, with respect to the orientation 1030 of the orientation layer are not equal to each other. Please be noted that, herein, the angle between the strip electrode and the orientation is an angle (acute angle) between a longitudinal direction of the strip electrode and the orientation.

Also, please note following several points:

First point, the liquid crystal display apparatus comprises the array substrate 10 and the package substrate. In a case where the array substrate 10 does not comprise a color filter, the package substrate is a color filter substrate. In a case where the array substrate 10 comprises a color filter, the package substrate is only used to mate with the array substrate 10 to form a box structure in which liquid crystal is filled. The color filter may be disposed at any suitable position herein.

Second point, as for a common array substrate 10, each pixel unit of which may comprise three or four sub pixel units, but the present invention is not limited to this, the number of the sub pixel units may be determined according to an actual configuration of the liquid crystal display panel.

Third point, limited to the preparation process of the orientation layer 103, all orientation layers 103 in the entire array substrate 10 have the same orientation. Thereby, in any one of the pixel units, the terms “at least two of angles of the strip electrodes 104, in the first sub pixel unit 10a, the second sub pixel unit 10b and the third sub pixel unit 10c, with respect to the orientation 1030 of the orientation layer are not equal to each other” only means that oblique angles of the strip electrodes 104 with respect to the orientation 1030 are not completely equal to each other.

Herein, the phrase “not completely equal to each other” means that for any one of the pixel units, the oblique angles of the strip electrodes 104 in two sub pixel units of the pixel unit with respect to the orientation 1030 may be different from each other, and the oblique angles of the strip electrodes 104 in other sub pixel units of the pixel unit with respect to the orientation 1030 may be equal to the oblique angle of the strip electrode 104 in one of the above two sub pixel units; or means that for any one of the pixel units, the oblique angles of the strip electrodes 104 in any two sub pixel units of the pixel unit with respect to the orientation 1030 are different from each other.

The oblique angle of the strip electrode 104 in each sub pixel unit with respect to the orientation 1030 may be determined according to actual structure parameters of the array substrate 10 and by performing a simulation match on a voltage-transmittance curve of the liquid crystal display apparatus, so that different colors of linearly polarized lights have the same transmittance through the liquid crystal display apparatus under the same voltage.

Fourth point, in all pixel units, the angles of the strip electrodes 104 in corresponding sub pixel units at the same relative position with respect to the orientation 1030 are equal to each other.

For example, if each of the pixel units comprises the first sub pixel unit, the second sub pixel unit and the third sub pixel unit which are sequentially arranged from left to right, then the first sub pixel unit in any one pixel unit corresponds to the first sub pixel unit in any another pixel unit, the second sub pixel unit in any one pixel unit corresponds to the second sub pixel unit in any another pixel unit, and the third sub pixel unit in any one pixel unit corresponds to the third sub pixel unit in any another pixel unit.

According to an exemplary embodiment of the present invention, there is also provided a liquid crystal display apparatus comprising an array substrate 10, a package substrate, a liquid crystal layer between the array substrate 10 and the package substrate, polarizers provided at a light-inputting side and a light-outputting side of the liquid crystal display apparatus, respectively, and a backlight source.

The array substrate 10 comprises a plurality of pixel units arranged in an array. Each of the pixel units comprises at least a first sub pixel unit 10a, a second sub pixel unit 10b and a third sub pixel unit 10c. Each of the sub pixel units comprises a thin film transistor 100, a pixel electrode 101 electrically connected to a drain electrode of the thin film transistor 100, a common electrode 102, and an orientation layer 103. At least one of the pixel electrode 101 and the common electrode 102 in each of the sub pixel units is configured to be a strip electrode 104.

Alternatively, at least two of angles of the strip electrodes 104, in the first sub pixel unit 10a, the second sub pixel unit 10b and the third sub pixel unit 10c, with respect to the orientation 1030 of the orientation layer 103 are not equal to each other.

A white light emitted from the backlight source is a polychromatic light comprising a red light, a green light, a blue light. Thereby, after passing through a polarizer at the light-inputting side of the liquid crystal display apparatus, the white light is converted into a linearly polarized white light. Since the red light, the green light and the blue light in the white light have different wavelengths, if the linearly polarized white light passes through the liquid crystal layer with same thickness and same deflection angle, a linearly polarized red light, a linearly polarized green light and a linearly polarized blue light in the linearly polarized white light will show different degrees of variation in the polarization direction. As a result, under the same voltage, transmittances of the linearly polarized red light, the linearly polarized green light and the linearly polarized blue light transmitting through a polarizer at a light-outputting side of the liquid crystal display apparatus are different from each other.

In order to overcome the above problem, in an exemplary embodiment of the present invention, angles of strip electrodes 104 in various sub pixel units of each pixel unit in the array substrate 10 with respect to the orientation 1030 of the orientation layer are configured based on a certain relation. In this way, under the same voltage, the linearly polarized red light, the linearly polarized green light and the linearly polarized blue light can transmit through the polarizer at the light-outputting side of the liquid crystal display apparatus in substantially the same light transmittance. Thereby, it reduces the chromatic aberration between a color generated by mixing lights of different sub pixel regions in different grayscales and an actual color, improving the display effect of the liquid crystal display apparatus.

In an exemplary embodiment of the present invention, one sub pixel unit in the array substrate 10 corresponds to one color filter in the color filter, for example, a red filter. After a linearly polarized white light passes through one color filter corresponding to any one sub pixel unit in the array substrate 10, for example, a red filter, the linearly polarized white light only can be converted into a linearly polarized red light corresponding to the red filter. Thereby, during configuring the angle of the strip electrode 104 in the sub pixel unit with respect to the orientation of the orientation layer, it only needs to consider the linearly polarized red light emitted from the red filter. Similarly, during configuring the angles of the strip electrodes 104 in other two sub pixel units with respect to the orientation of the orientation layer, it also only needs to consider a linearly polarized green light and a linearly polarized blue light emitted from a green filter and a blue filter, respectively.

Also, the relation among the angles of the strip electrodes 104 in various sub pixel units with respect to the orientation 1030 may be determined according to actual structure parameters of the array substrate 10 and by performing a simulation match on a voltage-transmittance curve of the liquid crystal display apparatus.

Alternatively, as shown in FIG. 4, each of the pixel units in the array substrate 10 may only comprise the first sub pixel unit 10a, the second sub pixel unit 10b and the third sub pixel unit 10c.

Further, the angle of the strip electrode 104 in the first sub pixel unit 10a with respect to the orientation 1030 of the orientation layer is configured to be greater than or equal to the angle of the strip electrode 104 in the second sub pixel unit 10b with respect to the orientation 1030 of the orientation layer. The angle of the strip electrode 104 in the second sub pixel unit 10b with respect to the orientation 1030 of the orientation layer is configured to be greater than or equal to the angle of the strip electrode 104 in the third sub pixel unit 10c with respect to the orientation 1030 of the orientation layer.

Herein, the angle (a first angle) between the strip electrode 104 in the first sub pixel unit 10a and the orientation 1030 of the orientation layer may be set to be a; the angle (a second angle) between the strip electrode 104 in the second sub pixel unit 10b and the orientation 1030 of the orientation layer may be set to be b; and the angle (a third angle) between the strip electrode 104 in the third sub pixel unit 10c and the orientation 1030 of the orientation layer may be set to be c. Then, the angles between the strip electrodes 104 in the first, second and third sub pixel units and the orientation 1030 of the orientation layer may satisfy a relation: a≧b≧c, wherein at least two of a, b and c are not equal to each other.

In this case, the array substrate 10 may further comprise a color filter. The color filter comprises a red filter, a green filter and a blue filter. The red filter corresponds to the first sub pixel unit 10a, the green filter corresponds to the second sub pixel unit 10b, and the blue filter corresponds to the third sub pixel unit 10c.

Alternatively, the package substrate is configured to be a color filter substrate, and the color filter substrate comprises a color layer. The first sub pixel unit 10a may correspond to a red filter in the color layer of the color filter substrate; the second sub pixel unit 10b may correspond to a green filter in the color layer of the color filter substrate; and the third sub pixel unit 10c may correspond to a blue filter in the color layer of the color filter substrate.

Further, as shown in FIG. 5, each of the pixel units may further comprise a fourth sub pixel unit 10d. In this case, the color filter of the array substrate 10 may further comprise a white filter or a yellow filter. Alternatively, the color layer of the color filter substrate may further comprise a white filter or a yellow filter. The fourth sub pixel unit 10d may correspond to the white filter or the yellow filter.

Herein, an oblique angle of a strip electrode 104 in the fourth sub pixel unit 10d with respect to the orientation 1030 of the orientation layer may be determined according to actual structure parameters of the array substrate 10 and by performing a simulation match on a voltage-transmittance curve of the liquid crystal display apparatus, so that different colors of linearly polarized lights have the same transmittance through the liquid crystal display apparatus under the same voltage.

Based on the above description, alternatively, the array substrate 10 may be an In-Plane Switch (IPS) type array substrate. In this case, as shown in FIG. 1, the pixel electrode 101 and the common electrode 102 are arranged in the same layer and spaced from each other, and the pixel electrode 101 and the common electrode 102 both are configured to be the strip electrode 104. An angle of the pixel electrode 101 with respect to the orientation 1030 of the orientation layer is equal to an angle of the common electrode 102 with respect to the orientation 1030 of the orientation layer.

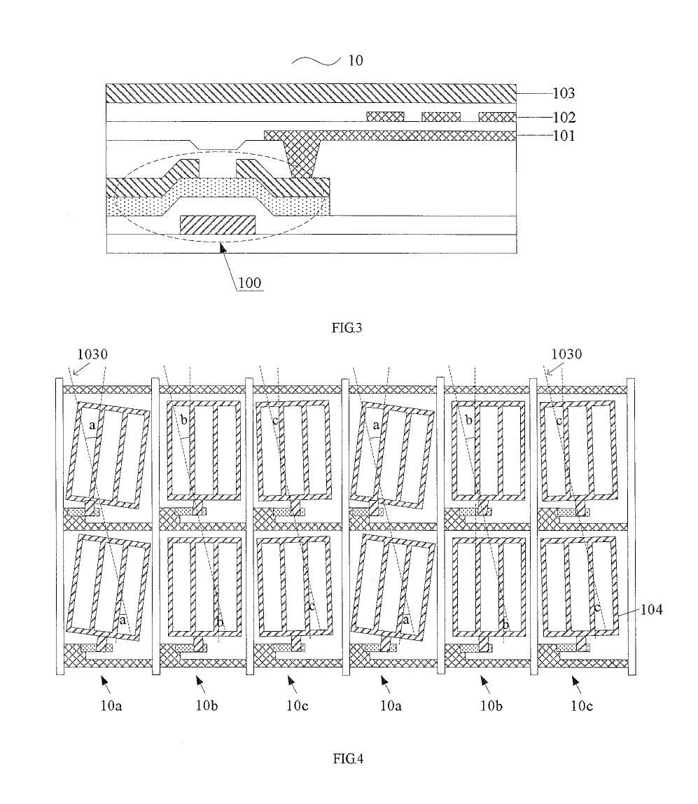

Or alternatively, the array substrate 10 may be an Advanced-super Dimensional Switching (ADS) type array substrate. In this case, as shown in FIGS. 2-3, the pixel electrode 101 and the common electrode 102 are not arranged in the same layer, and an upper one of the pixel electrode 101 and the common electrode 102 is configured to be the strip electrode, and a lower one of the pixel electrode 101 and the common electrode 102 is configured to be a plate electrode. Thereby, it only needs to configure the upper one of the pixel electrode 101 and the common electrode 102 to have an angle with respect to the orientation 1030 of the orientation layer.

Please be noted that, in embodiments of the present invention, only the relation among the angles of the strip electrodes 104 in various sub pixel units with respect to the orientation 1030 of the orientation layer is defined, and it does not define a width of the strip electrode 104 and the space between adjacent strip electrodes 104. The width of the strip electrode 104 and the space between adjacent strip electrodes 104 may be determined according to the structure of different array substrate 10.

Hereafter, it will perform a simulation match on a voltage-transmittance curve of the liquid crystal display apparatus by suitably setting the angles of the strip electrodes 104 in the first, second and third sub pixel units with respect to the orientation 1030 of the orientation layer.

If the angles of the strip electrodes 104 with respect to the orientation 1030 of the orientation layer are set to be too small, it can obtain a liquid crystal display apparatus having high transmittance, but the liquid crystal response speed becomes slow. If the angles of the strip electrodes 104 with respect to the orientation 1030 of the orientation layer are set to be too large, it can obtain a liquid crystal display apparatus having quick response, but the high transmittance becomes low. Thereby, in order to well match the transmittance and the liquid crystal response speed, as for a small sized liquid crystal display apparatus, the angles of the strip electrodes 104 with respect to the orientation 1030 of the orientation layer may be set to be in a range of 5°˜11°. As for a large sized liquid crystal display apparatus, the angles of the strip electrodes 104 with respect to the orientation 1030 of the orientation layer may be set to be greater than 11°.

Based on the above description, further, as for the small sized liquid crystal display apparatus, the angle of the strip electrode 104, in the first sub pixel unit 10a corresponding to the red filter, with respect to the orientation 1030 of the orientation layer may be set to be in a range of 7°˜11°; the angle of the strip electrode 104, in the second sub pixel unit 10b corresponding to the green filter, with respect to the orientation 1030 of the orientation layer may be set to be in a range of 7°˜11°; and the angle of the strip electrode 104, in the third sub pixel unit 10c corresponding to the blue filter, with respect to the orientation 1030 of the orientation layer may be set to be in a range of 5°˜9°.

In the above ranges, the angle (the first angle) of the strip electrode 104, in the first sub pixel unit 10a corresponding to the red filter, with respect to the orientation 1030 of the orientation layer may be set to be equal to the angle (the second angle) of the strip electrode 104, in the second sub pixel unit 10b corresponding to the green filter, with respect to the orientation 1030 of the orientation layer. The angle (the third angle) of the strip electrode 104, in the third sub pixel unit 10c corresponding to the blue filter, with respect to the orientation 1030 of the orientation layer is set to be less than the first angle and the second angle by 1°˜2°, so as to avoid the chromatic aberration from becoming too large at a low gray scale.

In an example, if the angles of the strip electrodes 104 in the three sub pixel units, corresponding to the red filter (with a wavelength of 630 nm), the green filter (with a wavelength of 550 nm), the blue filter (with a wavelength of 430 nm) in the color layer of the color filter substrate, with respect to the orientation 1030 of the orientation layer are all set to be equal to 7°, and a simulation match is performed on the voltage-transmittance curve of the liquid crystal display apparatus.

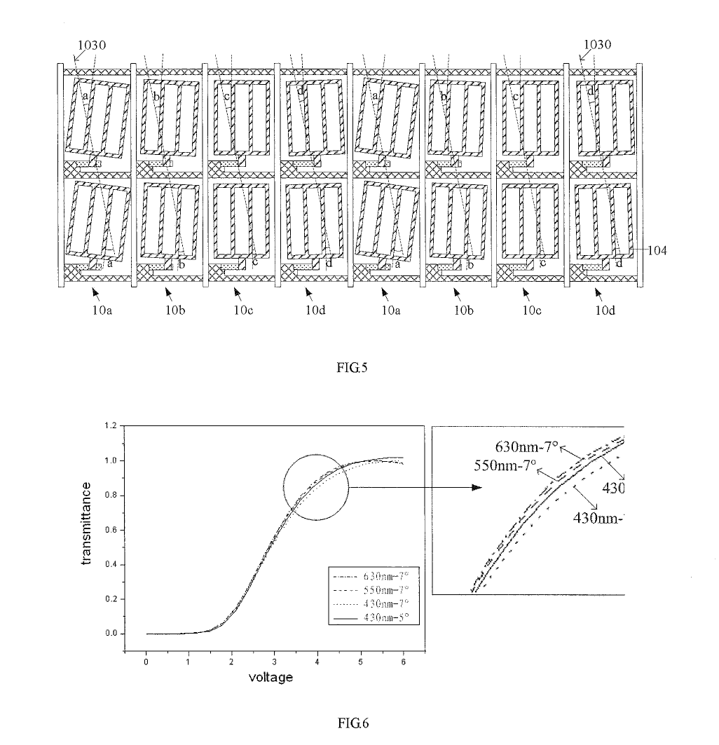

Herein, the liquid crystal layer has a thickness of 3.6 nm, the birefringence of liquid crystal molecules in the liquid crystal layer is 0.99, the strip electrode has a width of 2 nm, and a space between adjacent strip electrodes is 4 nm. After simulation, a voltage-transmittance curve is obtained, as shown in FIG. 6. It can be seen that the voltage-transmittance curve)(630 nm-7° corresponding to the red filter substantially conforms to the voltage-transmittance curve)(550 nm-7° corresponding to the green filter, but the voltage-transmittance curve)(630 nm-7° and the voltage-transmittance curve)(550 nm-7° both are quietly different from the voltage-transmittance curve)(430 nm-7° corresponding to the blue filter.

In the above example, the linearly polarized red light, the linearly polarized green light and the linearly polarized blue light show different degrees of optical phase delay during passing through the liquid crystal layer with same thickness and same deflection angle. Thereby, the linearly polarized red light, the linearly polarized green light and the linearly polarized blue light show different degrees of variation in the polarization direction after passing through the liquid crystal layer. As a result, under the same voltage, transmittances of the linearly polarized red light, the linearly polarized green light and the linearly polarized blue light transmitting through the color filter substrate and the polarizer at the light-outputting side of the liquid crystal display apparatus are different from each other. In the above example, the voltage-transmittance curve corresponding to the red filter and the voltage-transmittance curve corresponding to the green filter are approximately same, but quietly different from the voltage-transmittance curve corresponding to the blue filter. Consequently, the chromatic aberration is produced in the liquid crystal display apparatus during displaying an image, especially, a white image shows a yellow chromatic aberration in different gray-scales.

In order to well match the voltage-transmittance curve corresponding to the blue filter with the voltage-transmittance curves corresponding to the red filter and the green filter, in an example, the angles of the strip electrodes 104 in the sub pixel units, corresponding to the red filter and the green filter in the color filter substrate, with respect to the orientation 1030 of the orientation layer both are set to be equal to 7°, the angle of the strip electrode 104 in the sub pixel unit, corresponding to the blue filter in the color filter substrate, with respect to the orientation 1030 of the orientation layer is set to be equal to 5°, and a simulation match is performed again on the voltage-transmittance curve of the liquid crystal display apparatus.

The voltage-transmittance curve obtained in this simulation match is shown in FIG. 6. It can be seen that the voltage-transmittance curve (630 nm-7°) corresponding to the red filter, the voltage-transmittance curve (550 nm-7°) corresponding to the green filter, and the voltage-transmittance curve (430 nm-5°) corresponding to the blue filter are proximately same and well matched with each other. It means that the linearly polarized red light, the linearly polarized green light and the linearly polarized blue light, which have different wavelengths, have approximately the same transmittance under the same voltage. In this way, it can overcome the above problem that the white image displaced in the liquid crystal display apparatus shows the yellow chromatic aberration in different gray-scales. Of course, it also can reduce the chromatic aberration appeared in other composite color image.

As a result, based on the above simulation match, finally, the angles of the strip electrodes 104 in the first sub pixel unit 10a and the second sub pixel unit 10b, corresponding to the red filter and the green filter, with respect to the orientation 1030 of the orientation layer both are set to be equal to 7°, the angle of the strip electrode 104 in the third sub pixel unit 10c, corresponding to the blue filter, with respect to the orientation 1030 of the orientation layer is set to be equal to 5°.

In the above case, the angles of the strip electrodes 104 in the three sub pixel units 10a, 10b and 10c with respect to the orientation 1030 of the orientation layer satisfy a relation expression: a=b>c.

In an exemplary embodiment of the present invention, there is also provided a method of manufacturing the array substrate 10. The array substrate 10 comprises a plurality of pixel units arranged in an array. Each of the pixel units comprises at least a first sub pixel unit 10a, a second sub pixel unit 10b and a third sub pixel unit 10c. The method may comprise step of: as for any sub pixel unit, forming a thin film transistor 100, a pixel electrode 101 and a common electrode 102 on a substrate, and forming an orientation layer 103 on the substrate on which the thin film transistor 100, the pixel electrode 101 and the common electrode 102 have been formed. At least one of the pixel electrode and the common electrode in each of the sub pixel units is configured to be a strip electrode. At least two of angles of the strip electrodes 104, in the first sub pixel unit 10a, the second sub pixel unit 10b and the third sub pixel unit 10c, with respect to the orientation 1030 of the orientation layer are not equal to each other.

Please be noted that the thin film transistor 100 formed on the substrate may be a top gate type thin film transistor or a bottom gate type thin film transistor.

Also, the pixel electrode 101 or the common electrode 102 may be formed during forming the thin film transistor 100. The sequence of forming the pixel electrode 101, the common electrode 102 and the thin film transistor 100 may be designed according to an actual structure of the array substrate 10 and the manufacturing method.

Alternatively, as shown in FIG. 4, each of the pixel units may only comprise the first sub pixel unit 10a, the second sub pixel unit 10b and the third sub pixel unit 10c.

In this embodiment, the angle of the strip electrode 104 in the first sub pixel unit 10a with respect to the orientation 1030 of the orientation layer is configured to be greater than or equal to the angle of the strip electrode 104 in the second sub pixel unit 10b with respect to the orientation 1030 of the orientation layer. The angle of the strip electrode 104 in the second sub pixel unit 10b with respect to the orientation 1030 of the orientation layer is configured to be greater than or equal to the angle of the strip electrode 104 in the third sub pixel unit 10c with respect to the orientation 1030 of the orientation layer. In addition, at least two of the above angles are not equal to each other.

Based on the above description, in an exemplary embodiment, the angle of the strip electrode 104 in the first sub pixel unit 10a with respect to the orientation 1030 of the orientation layer may be set to be in a range of 7°˜11°; the angle of the strip electrode 104 in the second sub pixel unit 10b with respect to the orientation 1030 of the orientation layer may be set to be in a range of 7°˜11°; and the angle of the strip electrode 104 in the third sub pixel unit 10c with respect to the orientation 1030 of the orientation layer may be set to be in a range of 5°˜9°.

Further, the angles of the strip electrodes 104 in the first sub pixel unit 10a and the second sub pixel unit 10b with respect to the orientation 1030 of the orientation layer may be set to be equal to 7°; and the angle of the strip electrode 104 in the third sub pixel unit 10c with respect to the orientation 1030 of the orientation layer may be set to be equal to 5°.

In this case, the array substrate 10 may further comprise a color filter. The color filter comprises a red filter, a green filter and a blue filter. In an example, the red filter corresponds to the first sub pixel unit 10a, the green filter corresponds to the second sub pixel unit 10b, and the blue filter corresponds to the third sub pixel unit 10c.

Alternatively, if the array substrate 10 is applied in the liquid crystal display apparatus, the package substrate may be a color filter substrate, and the color filter substrate comprises a color layer. In an example, the first sub pixel unit 10a may correspond to a red filter in the color layer of the color filter substrate; the second sub pixel unit 10b may correspond to a green filter in the color layer of the color filter substrate; and the third sub pixel unit 10c may correspond to a blue filter in the color layer of the color filter substrate.

Further, as shown in FIG. 5, each of the pixel units may further comprise a fourth sub pixel unit 10d.

In this case, the color filter of the array substrate 10 may further comprise a white filter or a yellow filter. Alternatively, the color layer of the color filter substrate may further comprise a white filter or a yellow filter. The fourth sub pixel unit 10d may correspond to the white filter or the yellow filter.

Alternatively, as shown in FIG. 1, the pixel electrode 101 and the common electrode 102 may be formed in the same layer and spaced from each other by a single patterning process. The pixel electrode 101 and the common electrode 102 each may be the strip electrode.

In the example shown in FIG. 1, each of the pixel electrode 101 and the common electrode 102 in any one of the sub pixel units defines an angle with respect to the orientation 1030 of the orientation layer, and the angles of the pixel electrode 101 and the common electrode 102 with respect to the orientation 1030 are equal to each other.

As for any one of the pixel units, a relation among the angles of the strip electrodes 104 in various sub pixel units with respect to the orientation 1030 may be determined according to a corresponding relation between the various sub pixel units and the color filters, and its description is omitted herein.

Alternatively, as shown in FIGS. 2-3, the pixel electrode 101 and the common electrode 102 may be formed in different layers by two times of patterning processes, respectively. In this case, at least an upper one of the pixel electrode 101 and the common electrode 102 is configured to be the strip electrode 104.

As shown in FIG. 2, the plate-like common electrode 102 is firstly formed by a single patterning process, and then the strip-like pixel electrode 101 is formed by a single patterning process.

As shown in FIG. 3, the plate-like pixel electrode 101 is firstly formed by a single patterning process, and then the strip-like common electrode 102 is formed by a single patterning process.

Thereby, in the above two embodiments, as for any one of the sub pixel units, it only needs to configure the strip electrode 104 (the upper one of the pixel electrode 101 and the common electrode 102) of the pixel electrode 101 and the common electrode 102 to have an angle with respect to the orientation 1030 of the orientation layer.

It should be appreciated for those skilled in this art that the above embodiments are intended to be illustrated, and not restrictive. Modifications or substitutions may be obvious to the above embodiments by those skilled in this art, and the modifications and the substitutions fall within the scope of the present invention. The scope of the present invention is defined in the claims and their equivalents.

1. An array substrate comprising a plurality of pixel units arranged in an array, the pixel units each comprising at least a first sub pixel unit, a second sub pixel unit and a third sub pixel unit, the sub pixel units each comprising a pixel electrode, a common electrode and an orientation layer, wherein
at least one of the pixel electrode and the common electrode in each of the sub pixel units is configured to be a strip electrode,
the strip electrode of the first sub pixel unit defines a first angle with respect to an orientation of the orientation layer, the strip electrode of the second sub pixel unit defines a second angle with respect to the orientation of the orientation layer, the strip electrode of the third sub pixel unit defines a third angle with respect to the orientation of the orientation layer, and
at least two of the first angle, the second angle and the third angle are not equal to each other.

2. The array substrate according to claim 1, wherein
the first sub pixel unit corresponds to a red sub pixel unit, the second sub pixel unit corresponds to a green sub pixel unit, and the third sub pixel unit corresponds to a blue sub pixel unit.

3. The array substrate according to claim 2, wherein
each of the pixel units comprises only three sub pixel units, that is, the first sub pixel unit, the second sub pixel unit and the third sub pixel unit,
the first angle is greater than or equal to the second angle, and
the second angle is greater than or equal to the third angle.

4. The array substrate according to claim 3, wherein
the first angle is in a range of 7°˜11°,
the second angle is in a range of 7°˜11°, and
the third angle is in a range of 5°˜9°.

5. The array substrate according to claim 4, wherein
the first angle is equal to the second angle, and
the third angle is less than the first angle by 1°˜2°.

6. The array substrate according to claim 1, wherein
the pixel electrode and the common electrode are arranged in the same layer and spaced from each other, and
the pixel electrode and the common electrode both are configured to be the strip electrode.

7. The array substrate according to claim 1, wherein
the pixel electrode and the common electrode are arranged in different layers, and
at least one of the pixel electrode and the common electrode located above the other of the pixel electrode and the common electrode is configured to be the strip electrode.

8. The array substrate according to claim 1, wherein
the first angles of the strip electrodes of the first sub pixel units in the plurality of pixel units are the same;
the second angles of the strip electrodes of the second sub pixel units in the plurality of pixel units are the same; and
the third angles of the strip electrodes of the third sub pixel units in the plurality of pixel units are the same.

9. The array substrate according to claim 3, further comprising:
a color filter comprising a red filter corresponding to the first sub pixel unit, a green filter corresponding to the second sub pixel unit, and a blue filter corresponding to the third sub pixel unit.

10. A liquid crystal display apparatus comprising the array substrate according to claim 1.

11. The liquid crystal display apparatus according to claim 10, further comprising:
a color filter substrate comprising a color layer, and
wherein the color layer comprises a red filter corresponding to the first sub pixel unit, a green filter corresponding to the second sub pixel unit, and a blue filter corresponding to the third sub pixel unit.

12. The liquid crystal display apparatus according to claim 10, wherein
the array substrate further comprises a color filter comprising a red filter corresponding to the first sub pixel unit, a green filter corresponding to the second sub pixel unit, and a blue filter corresponding to the third sub pixel unit.

13. A method of manufacturing an array substrate comprising a plurality of pixel units arranged in an array, the pixel units each comprising at least a first sub pixel unit, a second sub pixel unit and a third sub pixel unit, the sub pixel units each comprising a pixel electrode, a common electrode and an orientation layer,
the method comprising step of:
configuring at least one of the pixel electrode and the common electrode in each sub pixel unit to a strip electrode,
wherein the strip electrode of the first sub pixel unit defines a first angle with respect to an orientation of the orientation layer, the strip electrode of the second sub pixel unit defines a second angle with respect to the orientation of the orientation layer, the strip electrode of the third sub pixel unit defines a third angle with respect to the orientation of the orientation layer, and
wherein at least two of the first angle, the second angle and the third angle are not equal to each other.

14. The method according to claim 13, wherein
the first sub pixel unit corresponds to a red sub pixel unit, the second sub pixel unit corresponds to a green sub pixel unit, and the third sub pixel unit corresponds to a blue sub pixel unit.

15. The method according to claim 14, wherein
each of the pixel units comprises the first sub pixel unit, the second sub pixel unit and the third sub pixel unit,
the first angle is greater than or equal to the second angle, and
the second angle is greater than or equal to the third angle.

16. The method according to claim 15, wherein
the first angle is in a range of 7°˜11°,
the second angle is in a range of 7°˜11°, and
the third angle is in a range of 5°˜9°.

17. The method according to claim 16, wherein
the first angle is equal to the second angle, and
the third angle is less than the first angle by 1°˜2°.

18. A liquid crystal display apparatus, comprising:
a backlight source emitting a white light;
a light-inputting side polarizer, through which the white light from the backlight source is converted into a linearly polarized white light comprising a linearly polarized red light, a linearly polarized green light and a linearly polarized blue light; and
a plurality of pixel units arranged in an array, wherein the pixel units each comprising at least a first sub pixel unit, a second sub pixel unit and a third sub pixel unit, the sub pixel units each comprising a pixel electrode, a common electrode and an orientation layer, at least one of the pixel electrode and the common electrode in each of the sub pixel units is configured to be a strip electrode, the strip electrode of the first sub pixel unit defines a first angle with respect to an orientation of the orientation layer, the strip electrode of the second sub pixel unit defines a second angle with respect to the orientation of the orientation layer, the strip electrode of the third sub pixel unit defines a third angle with respect to the orientation of the orientation layer, and at least two of the first angle, the second angle and the third angle are not equal to each other;
a liquid crystal layer; and
a light-outputting side polarizer,
wherein the first angle, the second angle and the third angle are so configured that:
the linearly polarized red light, the linearly polarized green light and the linearly polarized blue light, which have passed through the liquid crystal layer with same thickness and same deflection angle, transmit through the light-outputting side polarizer in substantially the same light transmittance under the same voltage.
